(19) United States
(12) Patent Application Publication
(10) Pub. No.: US 2025/0264986 A1
(43) Pub. Date: Aug. 21, 2025

(54) USER INTERFACES FOR MANIPULATING AUDIO SIGNALS

(71) Applicant: DOLBY LABORATORIES LICENSING CORPORATION

(72) Inventors: Gregory Stephen BARBONE, Martinez, CA (US); Andrea Fanelli, Seattle, WA (US); Mark R. P. Thomas, Walnut Creek, CA (US); Margaret Margaret TOBIN, San Francisco, CA (US)

(73) Assignee: DOLBY LABORATORIES LICENSING CORPORATION, (omitted)

(21) Appl. No.: 19/053,810

(22) Filed: Feb. 14, 2025

Related U.S. Application Data
(60) Provisional application No. 63/554,084, filed on Feb. 15, 2024.

(51) Int. Cl. G06F 3/04845

(52) U.S. Cl. CPC G06F 3/04845

(57) ABSTRACT

Disclosed are systems, methods and user interfaces for manipulating audio data. In some embodiments, a method comprises: presenting a graphical user interface on a display device, the graphical user interface including a portion for displaying an image projection, the image projection including at least one sound source; receiving, with at least one processor, first user input associating a location of a beamformer with the at least one sound source; generating, with the at least one processor, first control metadata based on the selected location; and controlling, with the at least one processor, the beamformer location with the first control metadata.

### TECHNICAL FIELD

The present disclosure relates generally to audio processing, and more specifically to computer user interfaces for manipulating audio signals.

### BACKGROUND

A set of audio signals may be captured, processed and output through transducers (e.g., loudspeakers) with the aim to recreate a desired spatial listening experience or “audio scene,” for one or more listeners. The audio scene attempts to emulate the listening experience of a person in the environment from which the audio was captured. However, in some contexts, such as when producing media content for professional distribution, an audio scene that differs from the captured audio scene is desired.

### SUMMARY

Many existing techniques for manipulating audio signals using electronic devices are generally cumbersome, inefficient, time-intensive, and require extensive technical expertise. For example, some techniques associated with extended reality use a complex and time-consuming user interface (“UI”) which requires specific acoustic and production expertise. This is especially true for Ambisonics audio signals. These techniques require more time and more effort than necessary, wasting human resources (e.g., professional labor), hardware resources (e.g., energy usage, compute, etc.), and business resources (workstation availability, studio time, etc.). These deficiencies and other problems are reduced or eliminated by the embodiments described herein.

In accordance with some embodiments, a method comprises: presenting a graphical user interface on a display device, the graphical user interface including a portion for displaying an image projection, the image projection including at least one sound source; receiving, with at least one processor, first user input associating a location of a beamformer with the at least one sound source; generating, with the at least one processor, first control metadata based on the selected location; and controlling, with the at least one processor, the beamformer location with the first control metadata.

In accordance with some embodiments, the method further comprises: receiving, with the at least one processor, second user input selecting a gain of the beamformer; generating, with the at least one processor, second control metadata based on the selected gain; and controlling, with the at least one processor, the gain of the beamformer with the second control metadata.

In accordance with some embodiments, there are a plurality of sound sources in the visual content, and the method further comprises: generating, with the at least one processor, a heat map visualization based on a location of arrival of each sound source, the heatmap visualization indicating an intensity of each sound source of the plurality of sound sources; and overlaying, with the at least one processor, the heat map visualization on the image projection.

In accordance with some embodiments, the first user input selects an azimuth and elevation of a beamformer indicator on the image projection, the beamformer indicator representing the location of the beamformer.

In accordance with some embodiments, the sound source is part of a higher order Ambisonics (HOA) signal.

In accordance with some embodiments, the method further comprises receiving third user input including alignment data; and aligning the HOA signal with the image projection based on the third user input.

In accordance with some embodiments, aligning the HOA signal with the image projection further comprises applying a rotation transform to the HOA signal, wherein the rotation transform is based on the alignment data.

In accordance with some embodiments, the beamformer indicator is translucent or semitranslucent.

In accordance with some embodiments, the beam indicator includes a text label.

In accordance with some embodiments, the further comprises: receiving fourth user input selecting one of a plurality of modes; in accordance with selection of a first mode, outputting a mono audio object from the beamformer, where the mono object is associated with the sound source; in accordance with selection of a second mode, applying a gain to the mono object and re-encoding the mono audio object into a higher order Ambisonics (HOA) signal; and in accordance with selection of a third mode, amplifying a registered HOA signal in the location of the beamformer, and aggregating the mono audio object with the amplified registered HOA signal.

In accordance with some embodiments, a non-transitory computer-readable storage medium stores instructions that when executed by a computing apparatus, cause the computing apparatus to perform of any of the preceding methods.

In accordance with some embodiments, a computing apparatus comprises: a display; at least one processor; memory storing instructions that when executed by the at least one processor, cause the system to perform any of the preceding methods.

In accordance with some embodiments, a method performed at an electronic device including a display is described. The method comprises: receiving video data; receiving audio data contemporaneously captured with the video data in a common acoustic space; displaying, on the display device, a user interface including a playback window displaying the video data; determining alignment data; generating registered audio data by processing the audio data in accordance with the alignment data; and while displaying the user interface, receiving a sequence of one or more inputs corresponding to a selection of a first location within the playback window; in response to the sequence of one or more inputs: displaying a first affordance at the location the first location; and determining beamformer control data based on the first location; and generating a first audio signal by processing the registered audio data with a beamformer configured with the beamformer control data.

In accordance with some embodiments, a non-transitory computer-readable storage medium storing one or more programs configured to be executed by one or more processors of an electronic device with a display device is described. The one or more programs include instructions for: receiving video data; receiving audio data contemporaneously captured with the video data in a common acoustic space; displaying, on the display device, a user interface including a playback window displaying the video data; determining alignment data; generating registered audio data by processing the audio data in accordance with the alignment data; and while displaying the user interface, receiving a sequence of one or more inputs corresponding to a selection of a first location within the playback window; in response to the sequence of one or more inputs: displaying a first affordance at the location the first location; and determining beamformer control data based on the first location; and generating a first audio signal by processing the registered audio data with a beamformer configured with the beamformer control data.

In accordance with some embodiments, a transitory computer-readable storage medium storing one or more programs configured to be executed by one or more processors of an electronic device with a display device is described. The one or more programs include instructions for: receiving video data; receiving audio data contemporaneously captured with the video data in a common acoustic space; displaying, on the display device, a user interface including a playback window displaying the video data; determining alignment data; generating registered audio data by processing the audio data in accordance with the alignment data; and while displaying the user interface, receiving a sequence of one or more inputs corresponding to a selection of a first location within the playback window; in response to the sequence of one or more inputs: displaying a first affordance at the location the first location; and determining beamformer control data based on the first location; and generating a first audio signal by processing the registered audio data with a beamformer configured with the beamformer control data.

In accordance with some embodiments, an electronic device is described. The electronic device comprises a display device; one or more processors; and memory storing one or more programs configured to be executed by the one or more processors, the one or more programs including instructions for: receiving video data; receiving audio data contemporaneously captured with the video data in a common acoustic space; displaying, on the display device, a user interface including a playback window displaying the video data; determining alignment data; generating registered audio data by processing the audio data in accordance with the alignment data; and while displaying the user interface, receiving a sequence of one or more inputs corresponding to a selection of a first location within the playback window; in response to the sequence of one or more inputs: displaying a first affordance at the location the first location; and determining beamformer control data based on the first location; and generating a first audio signal by processing the registered audio data with a beamformer configured with the beamformer control data.

The disclosed embodiments describe above and herein provide electronic devices with faster, more efficient methods and interfaces for manipulating audio associated with extended reality content. Such methods and interfaces optionally complement or replace other methods for manipulating audio associated with extended reality content. Such methods and interfaces reduce the cognitive burden on a user and produce a more efficient human-machine interface. For computing devices, such methods and interfaces reduce use of computational resources and decrease energy usage.

The summary above is provided to introduce a selection of techniques in a simplified form, and not intended to identify key or essential features of the claimed subject matter, which are defined by the appended claims

### BRIEF DESCRIPTION OF DRAWINGS

FIG. 1 is a block diagram of an example system for manipulating extended reality content, according to one or more embodiments

FIG. 2 is an example graphical user interface showing a heatmap overlaid on an equirectangular image projection with beam indicators, according to one or more embodiments.

FIG. 3 is an example graphical user interface showing an equirectangular image captured by a virtual reality (VR) application with beam indicators, according to some embodiments

FIG. 4 is an example parametric interface for manipulating beamformer and HOA registration settings, according to one or more embodiments.

FIG. 5 is a flow diagram illustrating an example process for manipulating audio using electronic devices, according to one or more embodiments.

FIG. 6 is a block diagram of an example electronic device architecture suitable for implementing the processes described in reference to FIGS. 1-5, according to one or more embodiments.

Features and technical benefits other than those explicitly described above will be apparent from a reading of the following Detailed Description and a review of the associate drawings.

### DETAILED DESCRIPTION

In the following detailed description, numerous specific details are set forth to provide a thorough understanding of various described embodiments with reference to the accompanying drawings. The illustrative embodiments in the detailed description, drawings, and claims are not meant to be limiting. Other embodiments may be utilized, and other changes made, without departing from the spirit or scope of the present disclosure. In light of the present disclosure, it will be apparent to one of ordinary skill in the art that the various described features and implementations may be practiced without many of these specific details. In some instances, well-known methods, procedures, components, and circuits, have not been described in detail so as not to unnecessarily obscure aspects of the embodiments. Several features are described hereafter that can each be used independently of one another or with any combination of other features. Thus, the features may be arranged, substituted, combined, separated, or designed into other configurations, which is contemplated in light of the present disclosure.

### Nomenclature

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example implementation” and “an example implementation” are to be read as “at least one example implementation.” The term “another implementation” is to be read as “at least one other implementation.” The terms “determined,” “determines,” or “determining” are to be read as obtaining, receiving, computing, calculating, estimating, predicting, or deriving. In addition, in the following description and claims, unless defined otherwise, all technical and scientific terms used herein have the same meaning as commonly understood by one of ordinary skills in the art to which this disclosure belongs.

Throughout this disclosure, various terms are used to describe audio signals that may be captured, modified, and/or generated. For example, as used herein, the term “HOA scene” refers to a set of HOA audio signals representing an audio scene. Similarly, as will be discussed below, “registered HOA” refers to a set of HOA audio signals with a specific orientation relative to an image (e.g., relative to extended reality content).

The embodiments described herein may be generally described as techniques, where the term “technique” may refer to system(s), device(s), method(s), computer-readable instruction(s), module(s), component(s), hardware logic, and/or operation(s) as suggested by the context as applied herein.

### Example System Processing Framework

The set of signals representing an audio scene may be represented in various formats, including Ambisonics formats, which represent the audio scene in terms of a target acoustic wave-field that is recreated in the vicinity of the listening position. In particular, high order Ambisonics formats (HOA) provide enhanced spatial fidelity, and are efficient to capture and manipulate.

An electronic device can be used to process audio signals (e.g., edit, manipulate, filter, mix, etc.). In some embodiments, the electronic device is a desktop computer or workstation (e.g., digital audio workstation (DAW)). In some embodiments, the electronic device is portable (e.g., a notebook computer, tablet computer, or handheld device). In some embodiments, the electronic device is a wearable device such as a headset. In some embodiments, the electronic device has a touchpad.

In some embodiments, the device has a touch-sensitive surface (e.g., a “touch screen” or “touch screen display”). In some embodiments, the electronic device has hardware input mechanisms such as depressible buttons and/or rotatable input mechanisms. In some embodiments, the electronic device has an image-base gesture recognition input mechanism (e.g., for tracking hand or eye gestures).

In some embodiments, the electronic device includes a display device. The display device can be embedded in the electronic device or a standalone LCD or LED screen (e.g., television, monitor, etc.) or projector projecting onto a display surface. In some embodiments, the display device is a single display, or a pair of displays integrated into an XR headset.

In some embodiments, the electronic device has a graphical user interface (GUI), one or more processors, memory, and one or more modules, programs, or sets of instructions stored in the memory for performing multiple functions. In some embodiments, the user interacts with the GUI through finger contacts and gestures on the touch-sensitive surface and/or through rotating the rotatable input mechanism and/or through depressing hardware buttons and/or by hand/finger gestures detected by camera and/or sensor based systems.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

It is desirable to allow the user to perform various processing operations via a single user interface of the electronic device while keeping the interface simple and intuitive to use. Further, a user may want to perform different types of processing, such as adjusting relative levels associated sound sources within an audio scene or extracting elements of an audio scene for use with existing robust productions toolchains (e.g., object-based audio toolchains such as those for Dolby Atmos®). For audio signals associated with visual content (e.g., Extended Reality Content), it is desirable that such processing maintains consistency with the associated visual content which may be dynamic (e.g., including changes in position, viewpoint, or perspective). It is therefore also desirable to allow the user to efficiently perform such operations through a user interface in manner that automatically maintains audio video consistency.

The description below includes techniques to graphically identify sound source locations in an HOA scene associated with an image projection (e.g., 360° video), apply HOA beamforming to: a) spatially select sound sources in the HOA scene for user-specified location(s); b) manipulate gains of the beamformers in the user-specified locations and leave the remainder of the HOA scene unaffected; c) output an HOA signal representing the HOA scene; d) spatially select individual beamformers; and e) output a plurality of mono signals as part of an object-based workflow.

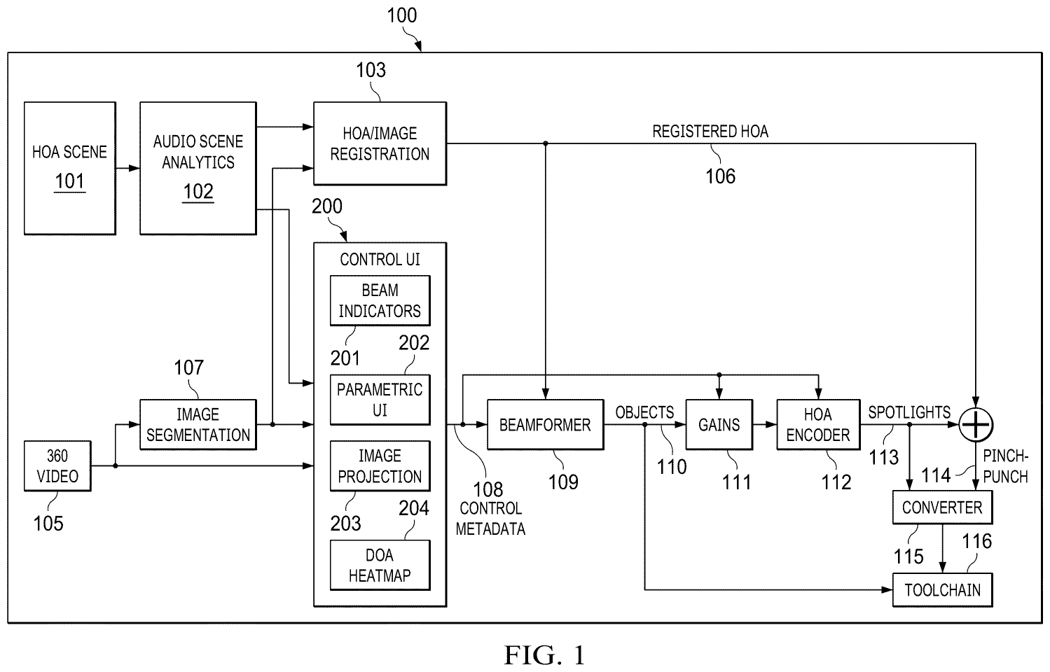

FIG. 1 is a block diagram of an example system 100 for manipulating audio content (e.g., extended reality content), according to one or more embodiments. As illustrated, system 100 receives HOA scene data 101 (e.g., as a set of audio signals) and video data 105 (e.g., video data associated with HOA scene 101) as inputs, which are acted upon by the various processes described below.

Acoustic scene analysis 102 estimates a direction of arrival (DOA) of each sound source from HOA scene data 101, such as voices or musical instruments. Acoustic scene analysis 102 also estimates signal power as a function of the DOA from HOA scene data 101.

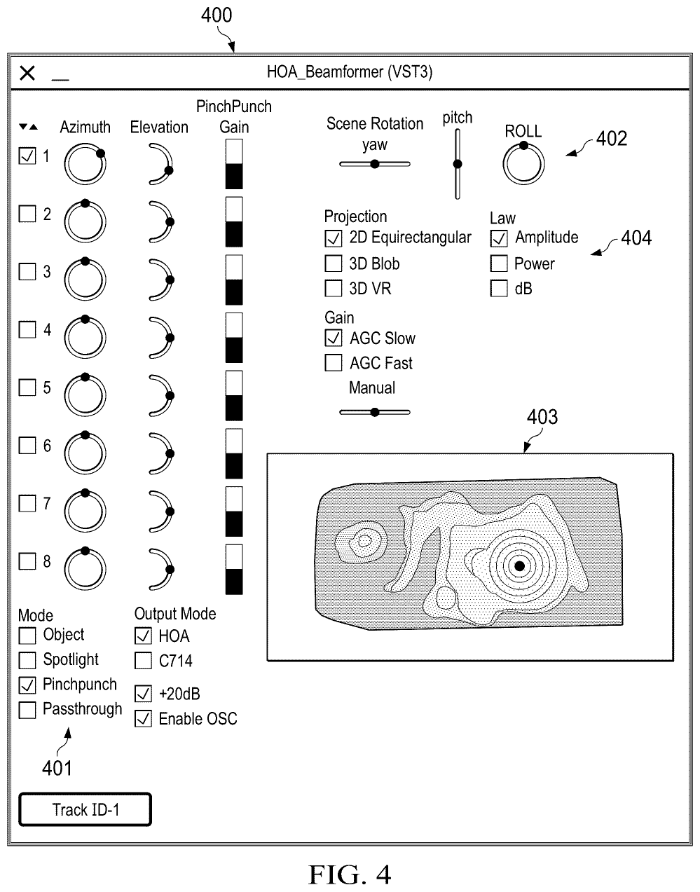

Video data 105 is provided to image segmentation 107, which segments the image in each frame of video data 105. HOA/image registration 103 aligns the HOA scene data with a corresponding segmented image using the signal power estimates from acoustic scene analysis 102 and outputs registered HOA signal 106. In some embodiments, HOA/image registration 103 determines and applies a rotation transform to the HOA scene data 101 to align the HOA scene data 101 with the segmented image, where the rotations are based on user input, as described in reference to FIG. 4.

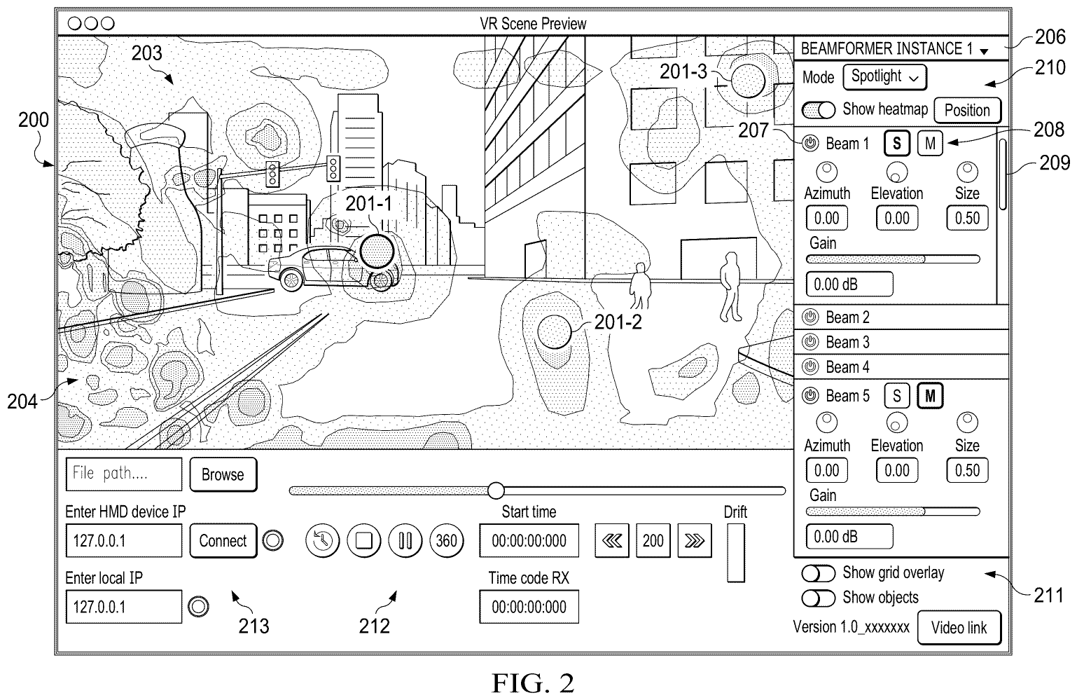

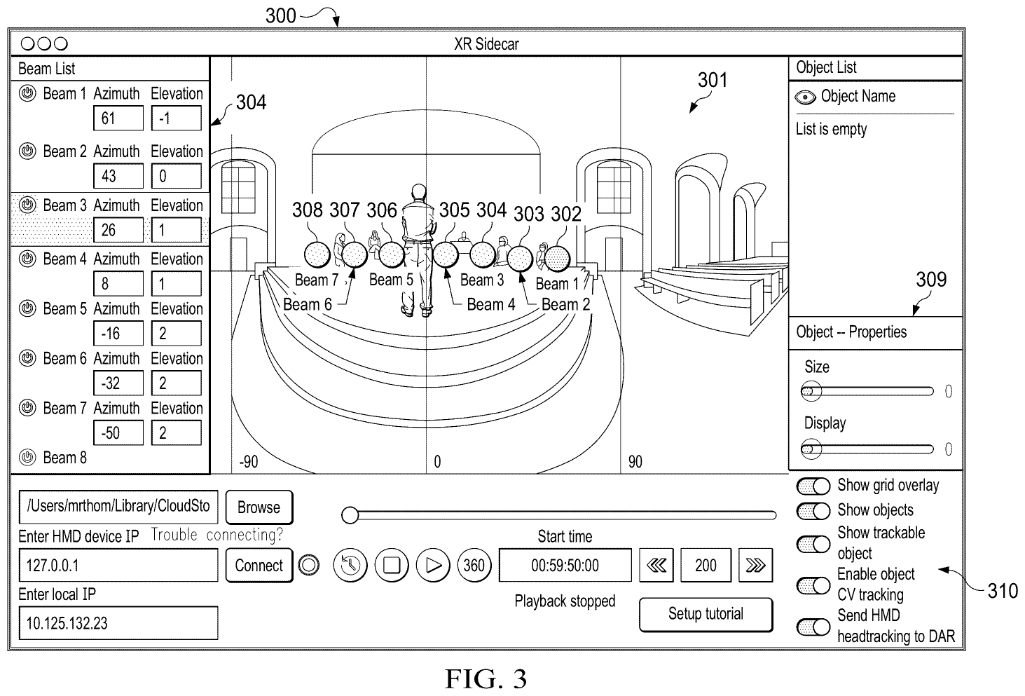

Example system 100 includes control UI 200 (See FIGS. 2 and 3), which includes various affordances to enable manipulation of content via a graphical user interface (GUI) displayed on a display device (e.g., computer screen, touch screen, tablet, etc.). Through user interaction with control UI 200, control metadata 108 is generated to control downstream audio processing.

Control UI 200 receives video data 105, estimates of DOA of sound sources from acoustic scene analysis 102 and estimates of DOA of sound sources from segmented images output by image segmentation 107. In some embodiments, control UI 200 receives data corresponding to various user inputs associated with beam indicators 201, parametric UI 202 (FIG. 4), image projection 203, and DOA heatmap 204.

Beam indicators 201 allow the user to place beamformers on image projection 203 and then monitor the beamformers. Parametric UI 202 provides control over the azimuth and elevation of beam indicators 201 (and thereby beamformers 109) on image projection 203. In some embodiments, image projection 203 is, for example, as an equirectangular, dual fisheye, or virtual reality (VR) image. DOA heatmap 204 generates a heatmap visualization based on the signal power estimates. The heat map visualization is overlaid on image projection 203, allowing areas of image projection 203 associated with high intensity sound sources to be visually identified by the user (e.g., See FIG. 2).

In some embodiments, the location of each beam indicator 201 can be set manually by the user, guided by the image projection 203, DOA heatmap 204, or by feedback through listening. As discussed above, control UI 200 generates and provides control metadata 108 to control beamformer 109 and HOA encoder 112. Control metadata 108 is determined based on the location(s) of beam indicators 201 on image projection 203 and optionally, additional specific data for beam indicators 201 (e.g., beam indicator mode, beam indicator enable/disable, gains, etc.).

Beamformer 109 receives registered HOA signal 106 and control metadata 108 and outputs mono audio objects 110 for the sound sources identified by beam indicators 201. Gains block 111 applies gains obtained from control metadata 108 to audio objects 110. HOA encoder 112 transforms the audio objects 110 to HOA format and outputs spotlights 113 (HOA encoded mono audio objects). Aggregated spotlights 113 are added to registered HOA signal 106 to generate PinchPunch data 114 (a gain for amplifying/attenuating registered HOA signal 106 in the direction of beamformer 109). Spotlights 113 and PinchPunch data 114 are converted by format converter 115 from HOA format into spatial assets that can be ingested into toolchain 116 (e.g., Dolby Atmos®) for further processing/manipulation.

### Example User Interfaces

FIG. 2 is an example user interface 200 showing DOA heatmap 204 overlaid on equirectangular image projection 203 with three beam indicators 201, labeled as 201-1, 201-2 and 201-3. As illustrated in FIG. 2, DOA heatmap 204 is used to assist a user in efficiently identifying or refining the location of sound sources in the HOA scene 101 associated with image projection 203 for downstream processing. For example, a user can manually (e.g., via user input) place beam indicators 201-1, 201-2, 201-3 at locations in image projection 203 that indicate a higher sound intensity that are identified by DOA heatmap 204. The location of the beam indicators 201 and gain (selected by the user) are provided to HOA beamformer 109 to provide a beam direction (θₖ, ϕₖ), as described in Equation (2) below. In the example shown, only beamformer 201-1 is active as indicated by the color of beam indicator 201-1 (e.g., a different color than beam indicators 201-2, 201-3). Although beam indicators 201 are shown in this example as circles, any suitable graphic or icon can be used. Also, any suitable augmentation of beamformer indicators 201-1, 201-2, 201-3 can be used to indicate its respective active or inactive status (e.g., change in appearance, size, shape, animation, etc.).

In some embodiments, DOA heatmap 204 identifies locations of sound sources in image projection 203 as colored regions (shown in FIG. 2 as darker gray regions), where the more intense the sound source the darker the color. The user can then use an input unit (e.g., a mouse, trackball) or their finger (four touch screens, or surfaces) to drag beam indicators 201 onto image projection 203 at the locations of the high intensity sound sources indicated by DOA heatmap 204. When beam indicators 201 at least partially overlap or are approximate to (e.g., within a threshold radial distance) of an associated sound source the beam indicate becomes associated with that sound source.

The locations and gains of sound sources in the HOA scene 101 that are identified by beam indicators 201 are included in control metadata 108 which is utilized by downstream processes, such as gains block 111, beamformer 109 and HOA encoder 112. Any number of sound sources in the HOA scene 101 can be identified using beam indicators 201 and the techniques described above.

FIG. 2 also shows example control affordances that are used to preview audio outputs from sound sources in the HOA scene 101 that are associated with beam indicators 201-1, 201-2, and 201-3. Some examples of controls affordances are beamformer control affordance 206 that includes various controls for changing the location (azimuth, elevation), size, and gain of the beamformer 109 associated with beam indicators 201-1, 201-2 and 201-3. Each beam indicator 201-1, 201-2, 201-3 can be activated with a power button affordance 207. The sound sources associated with the beam indicators 201-1 (e.g., a vehicle sound source), 201-2 (e.g., a sound source not visible as an object within the image projection), 201-3 (e.g., a building sound source) can be soloed or muted using solo/mute buttons affordances 208. Beamformer control affordances 209 are used to determine the azimuth, elevation and gain, respectively, of the beamformer. Mode affordances 210 allow selection one of a plurality of beamformer modes, including Object, Spotlight and PinchPunch modes, described below. Other control affordances 211 include controls (e.g., check boxes, buttons, etc.) to activate a grid overlay on image projection 203, show the locations of audio objects in image projection 203, show the locations of only trackable objects, etc. Video/audio playback controls 212 (e.g., scrubber, rewind, pause, play, etc.) allow the user to playback video data 105 with HOA scene 101 at a user-specified start time or time code.

FIG. 3 is an example user interface 300 showing an equirectangular image projection 301 captured by a virtual reality (VR) application with eight beam indicators. In this example, image projection 301 includes musicians performing on a stage. As shown seven of the eight beams are active resulting in display of beam indicators 302-308.

Beamformer list affordance 304 includes controls for beamformer 109 indicated by beam indicators 302-308. In this example, each beam indicator 302-308 is visually associated with one musician (each a sound source) as illustrated in FIG. 3. In some embodiments, each beam indicator 302-308 includes a text label to identify the beam by name and number (in this example), or any other suitable user-specified label. In some embodiments, beam indicators 302-308 are translucent or semitranslucent so that the sound sources behind the indicators are at least partially visible to the user to facilitate visual placement of beam indicators 302-308 by the user.

Beamformer list affordance 304 enables manual input of beam location (or review of azimuth and elevation data associated with graphically placed beams). In response to manual input via text field affordances in beamformer list affordance 304, corresponding changes are made to the locations of beamformer indicators 302-308 overlaid on image projection 301 (and vice versa). In other embodiments, the user can select a beam indicator from a tool bar or menu (not shown) in user interface 300 with their input device (mouse, finger), and drag and drop a beam indicator on or near the sound source. Each beam can be activated/deactivated with its own dedicated power button affordance as shown.

User interface 300 includes additional control affordances 309 and 310. Affordances 309 allow a user to change the properties (e.g., size, distance) of an object. The “show grid overlay” affordance 310 is activated, resulting in the vertical grid lines overlaid on equirectangular image projection 301 at −90, 0 and 90 degrees. The “show objects” affordance 310 is activated to show audio objects/sound sources. The “show trackable objects” affordance 310 is activated to show trackable objects/sound sources, which can be tracked by activating “object CV tracking” affordance 310, which uses computer vision (CV) to track objects, and “send HMD head tracking to DAR” affordance 310 for sending head mounted display (HMD) data to a headtracking component of a dynamic animation replacement (DAR) tool. Other controls in user interface 300 include but are not limited to video playback controls (e.g., rewind, pause/stop, play) and file management text input boxes and a browser, for entering an HMD device IP and a local router IP, etc., and search for files, respectively.

FIG. 4 is a parametric interface 400 for manipulating beamformer and registration settings, in accordance with one or more embodiments. On the left side of parametric interface 400 there are various affordances 401 for each beamformer, including azimuth and elevation controls (e.g., rotary dials) for determining the location of beamformers, checkboxes affordances for activating the beamformer controls, and PinchPunch gain affordances for changing PinchPunch gain. Below affordances 401 are checkbox affordances 405 to allow manual selection of beamformer modes (Object, Spotlight, PinchPunch, Passthrough) and affordances 406 to manual selection of output modes.

In “Object” mode, the output of beamformer 109 is a set of mono audio objects 110 that may be used directly with an object-based toolchain 116 (See Equation (2) below).

In “Spotlight” mode, gains block 111 (see FIG. 1) applies gains included in control metadata 108 to the mono audio objects 110 before re-encoding the mono audio objects 110 into the HOA domain with HOA encoder 112 (see Equation (3) below). This implicitly discards all sound sources of the original HOA scene 101, retaining only the sound sources selected by beamformer 109.

In “PinchPunch” mode (which is active in the current example), spotlights 113 are aggregated with registered HOA signal 106 (see Equation (4) below). The user's selection of a positive PinchPunch gain using the PinchPunch affordance amplifies the registered HOA signal 106 in the beamformer direction. The selection of a negative PinchPunch gain by the user attenuates the registered HOA signal 106 in the beamformer direction. In some embodiments a gain of “−1” cancels the registered HOA signal 106. The selection of “0” PinchPunch gain by the user leaves the original registered HOA signal 106 unmodified. Both “Spotlight” and “PinchPunch” modes return HOA signals and are spatial filtering techniques. By contrast, “Object” mode returns a set of mono audio objects 110.

Output modes include HOA formatting, C714 (convert HOA to 7.1.4 audio), adding +20 dB of gain and outputting Dolby Atmos® object-based sound control (OSC). The right side of parametric interface 400 includes HOA scene rotation affordances 402 that allow the user to align/register the HOA scene 101 with image projection 203 in HOA/image registration 103. In this example, affordances 402 include affordances for changing yaw, pitch and roll of the HOA scene 101. These angles are used to construct a rotation transform as described in Equation (1) below. Other suitable controls can also be used. Window 403 provides a three-dimensional visualization for assisting the user in aligning HOA scene 101 with image projection 203 using affordances 402.

In some embodiments, additional affordances 404 (e.g., checkboxes or other suitable affordances) are provided for selecting a projection type (e.g., 2D equirectangular, 3D blob, 3D virtual reality), a panning law (e.g., amplitude, power, dB) and gain for scaling the heatmap to improve visibility (e.g., AGC slow, AGC fast, manual).

### Example HOA Beamformer, DOA Heat Map and Modes

The equations below describe how a beamformer 109 is created and controlled by control metadata 108 for various modes. Also, creation of DOA heatmap 204 is described. The variables for the equations are defined in Table I below.

TABLE I
Variable Definitions

| | |
|---|---|
| l | HOA degree index |
| m | HOA order index |
| N | Maximum HOA order |
| n | Sample index |
| θ | Colatitude angle |
| ϕ | Azimuth angle |
| k | Beam index |
| K | Total beamformer beams |
| P | Total heatmap beams |
| α | Yaw rotation angle |
| β | Pitch rotation angle |
| γ | Roll rotation angle |
| Yₗ^{m}(θ, ϕ) | Spherical harmonic |
| Y | Spherical harmonic matrix (N + 1)² × P |
| x̌ₗ^{m}(n) | HOA signal |
| x̌(n) | HOA signal represented as a vector (N + 1)² × 1 |
| R(α, β, γ) | HOA rotation matrix (N + 1)² × (N + 1)² |
| x̅(θ, ϕ, n) | Beamformer output |
| šₗ^{m}(n) | Spotlight output |
| gₖ | Spotlight gain |
| C | HOA signal covariance (N + 1)² × (N + 1)² |
| σ² | Signal variance vector P × 1 |

In some embodiments, HOA scene 101, represented as signal x̆(n), is rotated to align with an image projection 103 by applying a suitable rotation matrix R(α, β, γ) derived from user-defined yaw, pitch, and roll angles (see FIG. 4),

$${{x}^{⌣}}^{′} ( n ) = R ( α , β , γ ) {x}^{⌣} ( n ) . \qquad ( 1 )$$

For brevity, the (⋅)′ will be omitted from here. An HOA beamformer for the kth beam direction is calculated by

$${\overline{x}}_{k} ( {θ}_{k} , {ϕ}_{k} , n ) = \frac{4 π}{{( N + 1 )}^{2}} {\sum }_{l = 0}^{N} {\sum }_{m = - l}^{l} {{x}^{⌣}}_{l}^{m} {Y}_{l}^{m} ( {θ}_{k} , {ϕ}_{k} ) , \qquad ( 2 )$$

where Yₗ^{m}(θₖ, ϕₖ) are the spherical harmonics evaluated in direction (θₖ, ϕₖ) and N is the maximum HOA order, typically 1-7. x̅ₖ(θₖ, ϕₖ, n) is the “Object” mode output. For “Spotlight” mode outputs, the objects/sound sources are reencoded in the HOA domain by HOA encoder 112 as

$${{s}^{⌣}}_{l}^{m} ( n ) = {\sum }_{k = 0}^{K - 1} {g}_{k} {\overline{x}}_{k} ( {θ}_{k} , {ϕ}_{k} , n ) {{Y}_{l}^{m} ( {θ}_{k} , {ϕ}_{k} )}^{*} , \qquad ( 3 )$$

where gₖ are arbitrary gains. “PinchPunch” mode adds the aggregated spotlights to the original HOA signal by

$${{p}^{⌣}}_{l}^{m} ( n ) = {{x}^{⌣}}_{l}^{m} + {{s}^{⌣}}_{l}^{m} ( n ) . \qquad ( 4 )$$

Conceptually, the DOA heatmap 204 is the energy (variance) of the object beams evaluated over a dense set of P directions. A more efficient approach is to change the order of operations and to first calculate the covariance of the HOA signal:

$$C = E [ {x}^{⌣} ( n ) {{x}^{⌣} ( n )}^{H} ] , \qquad ( 5 )$$

where E[⋅] denotes expectation over samples n. C may be smoothed over consecutive processing frames. The signal variance is found by

$${σ}^{2} = diag ( {Y}^{H} CY ) , \qquad ( 6 )$$

where Y is a matrix of spherical harmonics evaluated at the Nth order over P directions for example on equirectangular or near-uniform Fliege grids. P is typically in the high hundreds to low thousands.

### Example Processes

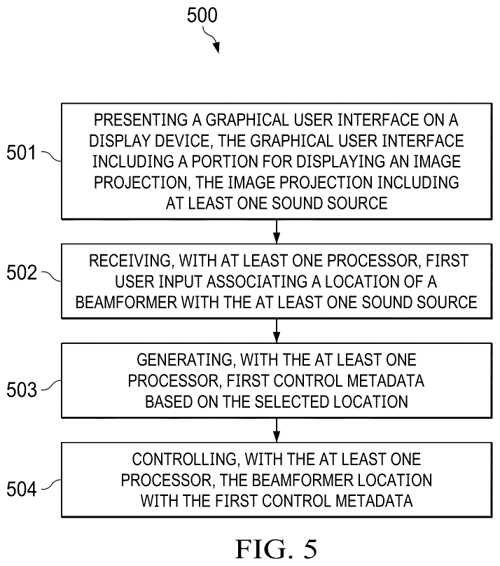

FIG. 5 is a flow diagram illustrating an example process 500 for manipulating audio using electronic devices, according to one or more embodiments. Process 500 is performed at an electronic device (e.g., electronic device 600 illustrated below). As described below, process 500 provides an intuitive way for manipulating audio (e.g., audio associated with extended reality content) using electronic devices. Process 500 reduces the cognitive burden on a user seeking to manipulating audio associated with extended reality content using electronic devices, thereby creating a more efficient human-machine interface.

Process 500 includes: presenting a graphical user interface on a display device, the graphical user interface including a portion for displaying an image projection, the image projection including at least one sound source (501); receiving, with at least one processor, first user input associating a location of a beamformer with the at least one sound source (502); generating, with the at least one processor, first control metadata based on the selected location (504); and controlling, with the at least one processor, the beamformer location with the first control metadata (505).

In some embodiments, the method is implemented at or on an electronic device that includes a plurality of audio output devices. In various embodiments, the audio output devices may be stereo headphones, transducers of a headset (e.g., speakers integrated into an XR/AR/VR headset), or a multi-channel surround sound system (e.g., 5.1, 7.1, 5.1.2, 5.1.4, 7.1.4, etc.).

### Example System Architecture

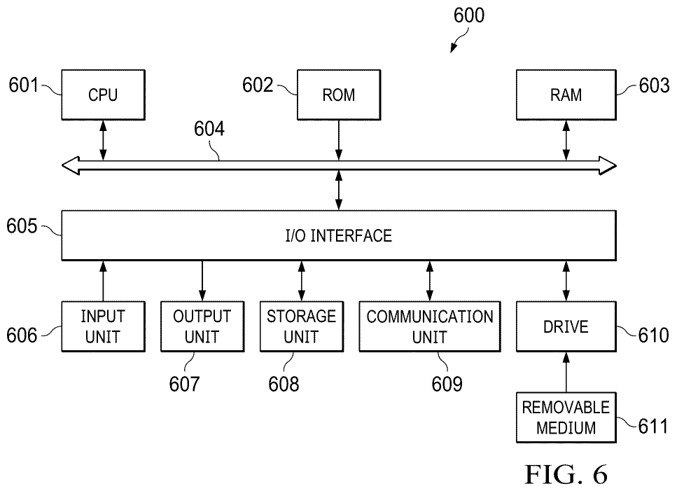

FIG. 6 is a block diagram of a system architecture 600 suitable for implementing example embodiments of the present disclosure. Architecture 600 includes but is not limited to devices, as previously described. Architecture 600 includes central processing unit (CPU) 601 which is capable of performing various processes in accordance with a program stored in, for example, read only memory (ROM) 602 or a program loaded from, for example, storage unit 608 to random access memory (RAM) 603. In RAM 603, the data required when CPU 601 performs the various processes is also stored, as required. CPU 601, ROM 602 and RAM 603 are connected to one another via bus 604. Input/output (I/O) interface 605 is also connected to bus 604.

The following components are connected to I/O interface 605: input unit 606, that may include a keyboard, a mouse, or the like; output unit 607 that may include a display such as a liquid crystal display (LCD) and one or more speakers; storage unit 608 including a hard disk, or another suitable storage device; and communication unit 609 including a network interface card such as a network card (e.g., wired or wireless). In some implementations, input unit 606 includes one or more microphones in different positions (depending on the host device) enabling capture of audio signals in various formats (e.g., mono, stereo, spatial, immersive, and other suitable formats). In some implementations, output unit 607 include systems with various number of speakers. Output unit 607 (depending on the capabilities of the host device) can render audio signals in various formats (e.g., mono, stereo, immersive, binaural, and other suitable formats).

In some embodiments, communication unit 609 is configured to communicate with other devices (e.g., via a network). Drive 610 is also connected to I/O interface 605, as required. Removable medium 611, such as a magnetic disk, an optical disk, a magneto-optical disk, a flash drive or another suitable removable medium is mounted on drive 610, so that a computer program read therefrom is installed into storage unit 608, as required. A person skilled in the art would understand that although architecture 600 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 909, and/or installed from the removable medium 611, as shown in FIG. 6.

Generally, various example embodiments of the present disclosure may be implemented in hardware or special purpose circuits (e.g., control circuitry), software, logic or any combination thereof. For example, the units discussed above can be executed by control circuitry (e.g., CPU 601 in combination with other components of FIG. 6), thus, the control circuitry may be performing the actions described in this disclosure. Some aspects may be implemented in hardware, while other aspects may be implemented in firmware or software which may be executed by a controller, microprocessor or other computing device (e.g., control circuitry).

Several enumerated embodiments (EE) are described below, with each embodiment identified by a corresponding number.
EE1: In some embodiments, a method is performed by an electronic device including a display device. The method includes: receiving video data and audio data captured in a common acoustic space; displaying, on the display device, a user interface including a playback window displaying the video data; while displaying the user interface, receiving first user input corresponding to a selection of a first location within the playback window; in response to the first user input, displaying a first affordance at the first location; determining first beamformer control data based on the first location; and generating a first audio signal by processing the audio data with a first beamformer configured with the first beamformer control data.
EE2: The method further comprises: while displaying the user interface, receiving second user input corresponding to a selection of a second location within the playback window that is different from the first location; in response to the second user input, displaying a second affordance at the second location; determining second beamformer control data based on the second location; and generating a second audio signal by processing the audio data with a second beamformer configured with the second beamformer control data.
EE3: The audio data is a higher Ambisonics (HOA) scene data.
EE4: Displaying the video data includes concurrently displaying a heatmap visualization as an overlay on the video data.
EE5: The first or second audio signals are mono audio objects.
EE6: The method further comprises determining third user input through a third affordance, the third user input generating alignment data for aligning the audio data with the video data.
EE7: Aligning the audio data with the video data includes applying a rotation transform to the audio data based on the alignment data.
EE8: In accordance with a determination of a first mode, outputting the first or second audio signal(s); in accordance with a determination of a second mode, processing the first or second audio signal, and encoding the processed signal(s) into higher order Ambisonics (HOA) format; and in accordance with a determination of a third mode, processing the first or second audio signal(s), encoding the processed signal(s) into HOA, and combining the encoded processed signal(s) with a registered HOA signal into an enhanced registered audio signal.

FIG. 5 is a flow diagram illustrating process 500 for manipulating audio associated with extended reality content using electronic devices, in accordance with one or more embodiments.

Process 500 begins when the electronic device (see FIG. 6) receives video data (501), and audio data (504) captured in an acoustic space. An electronic device (See FIG. 6) displays, on an output unit (e.g., a display device), a user interface including a playback window displaying the video data (506), determines alignment/registration data (508), and generates a registered audio signal by processing the audio data in accordance with the alignment/registration data (510).

While displaying the user interface, the electronic device, receives a sequence of one or more user inputs selecting a first location within the playback window (512). In response to a first input, the electronic device displays a first affordance at the first location (514), determines beamformer control data based on the first location (516), and generates a first audio signal by processing the first registered audio data with a beamformer configured with the beamformer control data (518).

In some embodiments, displaying the video data includes concurrently displaying a DOA heatmap as an overlay on a frame of video data 105 (an image projection 203). In some embodiments, the first or second audio signals are mono audio objects.

In some e embodiments, determining alignment/registration data includes performing at least one of acoustic scene analysis on the audio data, generation of a DOA heatmap based on the audio data or performing image segmentation on the video data.

In some embodiments, generating registered audio data includes applying a rotation transform to the audio data based on the alignment data.

In some embodiments, in accordance with determination of a first mode, the electronic device outputs the first or second audio signal(s). In accordance with determination of a second mode, the electronic device processes the first or second audio signal, and encodes the processed signal(s) into HOA format. In accordance with a determination of a third mode, the electronic device processes the first or second audio signal(s), encodes the processed signal(s) into HOA format, and combines the encoded processed signal(s) with the registered HOA audio signal into an enhanced registered audio signal.

In some embodiments, the electronic device includes a plurality of audio output devices, and the electronic device, while displaying the video data, outputs via the plurality of audio output devices, and in accordance with a selection provided by user input, the registered audio data, the first audio signal, the second audio signal, or the enhanced registered audio signal. In various embodiments, the audio output devices may be stereo headphones, transducers of a headset (e.g., speakers integrated into an XR/AR/VR headset), or a multi-channel surround sound system (e.g., 5.1, 7.1, 5.1.2, 5.1.4, 7.1.4, etc.).

While various aspects of the example embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may be non-transitory and may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general-purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

While this document contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising:
presenting a graphical user interface on a display device, the graphical user interface including a portion for displaying an image projection, the image projection including at least one sound source;
receiving, with at least one processor, first user input associating a location of a beamformer with the at least one sound source;
generating, with the at least one processor, first control metadata based on the selected location; and
controlling, with the at least one processor, the beamformer location with the first control metadata.

2. The method according to claim 1, further comprising:
receiving, with the at least one processor, second user input selecting a gain of the beamformer;
generating, with the at least one processor, second control metadata based on the selected gain; and
controlling, with the at least one processor, the gain of the beamformer with the second control metadata.

3. The method according to claim 1, wherein there are a plurality of sound sources in the visual content, the method further comprising:
generating, with the at least one processor, a heat map visualization based on a location of arrival of each sound source, the heatmap visualization indicating an intensity of each sound source of the plurality of sound sources; and
overlaying, with the at least one processor, the heat map visualization on the image projection.

4. The method according to claim 1, wherein the first user input selects an azimuth and elevation of a beamformer indicator on the image projection, the beamformer indicator representing the location of the beamformer.

5. The method according to claim 1, wherein the sound source is part of a higher order Ambisonics (HOA) signal.

6. The method according to claim 5, further comprising:
receiving third user input including alignment data; and
aligning the HOA signal with the image projection based on the third user input.

7. The method according to claim 6, wherein aligning the HOA signal with the image projection further comprises applying a rotation transform to the HOA signal, wherein the rotation transform is based on the alignment data.

8. The method according to claim 4, wherein the beamformer indicator is translucent or semitranslucent.

9. The method according to claim 4, wherein the beam indicator includes a text label.

10. The method according to claim 1, further comprising:
receiving fourth user input selecting one of a plurality of modes;
in accordance with selection of a first mode, outputting a mono audio object from the beamformer, where the mono object is associated with the sound source;
in accordance with selection of a second mode, applying a gain to the mono object and re-encoding the mono audio object into a higher order Ambisonics (HOA) signal; and
in accordance with selection of a third mode, amplifying a registered HOA signal in the location of the beamformer, and aggregating the mono audio object with the amplified registered HOA signal.

11. A non-transitory computer-readable storage medium storing instructions that when executed by a computing apparatus, cause the computing apparatus to:
present a graphical user interface on a display device, the graphical user interface including a portion for displaying an image projection, the image projection including at least one sound source;
receive, with at least one processor, first user input associating a location of a beamformer with the at least one sound source;
generate, with the at least one processor, first control metadata based on the selected location; and
control, with the at least one processor, the beamformer location with the first control metadata.

12. A computing apparatus comprising:
a display;
at least one processor;
memory storing instructions that when executed by the at least one processor, cause the system to:
present a graphical user interface on the display device, the graphical user interface including a portion for displaying an image projection, the image projection including at least one sound source;
receive, with the at least one processor, first user input associating a location of a beamformer with the at least one sound source;
generate, with the at least one processor, first control metadata based on the selected location; and
control, with the at least one processor, the beamformer location with the first control metadata.
